(19) United States
(12) Patent Application Publication
(10) Pub. No.: US 2025/0355725 A1
(43) Pub. Date: Nov. 20, 2025

(54) PERFORMANCE TUNING OF A DATA TRANSFORM ACCELERATOR

(71) Applicant: MaxLinear, Inc., Carlsbad, CA (US)

(72) Inventors: Pinaki Shankar Chanda, San Diego, CA (US); Michael Ray Ham, San Jose, CA (US)

(73) Assignee: MaxLinear, Inc., Carlsbad, CA (US)

(21) Appl. No.: 19/204,213

(22) Filed: May 9, 2025

Related U.S. Application Data
(60) Provisional application No. 63/648,093, filed on May 15, 2024.

(51) Int. Cl. G06F 9/50; G06F 11/34

(52) U.S. Cl. CPC G06F 9/5083; G06F 11/3433; G06F 2209/5019

(57) ABSTRACT

A method may include obtaining multiple tunable parameters associated with a data transform accelerator operable to perform data transform operations. The method may also include configuring a resource configuration vector based on the multiple tunable parameters. The method may further include obtaining a target performance metric. The method may also include measuring one or more performance metrics associated with the data transform accelerator. The method may further include automatically tuning at least one tunable parameter of the multiple tunable parameters to obtain tuned parameters in response to a performance metric of the one or more performance metrics failing to satisfy the target performance metric. The method may also include updating the resource configuration vector in view of the tuned parameters.

### CROSS REFERENCE TO RELATED APPLICATIONS

This U.S. patent application claims priority to U.S. Provisional Patent Application No. 63/648,093, titled “PERFORMANCE TUNING IN A DATA TRANSFORM ACCELERATOR,” and filed on May 15, 2024, the disclosure of which is hereby incorporated by reference in its entirety.

### TECHNICAL FIELD

This disclosure generally relates to data transform acceleration, and more specifically, to performance tuning of a data transform accelerator.

### BACKGROUND

Unless otherwise indicated herein, the materials described herein are not prior art to the claims in the present application and are not admitted to be prior art by inclusion in this section.

Data transform accelerators are co-processor devices that are used to accelerate data transform operations for various applications such as data analytics applications, big data applications, storage applications, cryptographic applications, and networking applications. For example, a data transform accelerator can be configured as a storage accelerator and/or a cryptographic accelerator.

The subject matter claimed in the present disclosure is not limited to implementations that solve any disadvantages or that operate only in environments such as those described above. Rather, this background is only provided to illustrate one example technology area where some implementations described in the present disclosure may be practiced.

### SUMMARY

In an example embodiment, a method may include obtaining multiple tunable parameters associated with a data transform accelerator operable to perform data transform operations. The method may also include configuring a resource configuration vector based on the multiple tunable parameters. The method may further include obtaining a target performance metric. The method may also include measuring one or more performance metrics associated with the data transform accelerator. In response to a performance metric of the one or more performance metrics failing to satisfy the target performance metric, the method may further include automatically tuning at least one tunable parameter of the multiple tunable parameters to obtain tuned parameters. The method may also include updating the resource configuration vector in view of the tuned parameters.

In another embodiment, a system may include a data transform accelerator and a host device. The data transform accelerator may be operable to perform data transform operations. The host device may be in communication with the data transform accelerator and may be operable to obtain multiple tunable parameters associated with the data transform accelerator. The host device may also be operable to configure a resource configuration vector based on the multiple tunable parameters. The host device may further be operable to obtain a target performance metric. The host device may also be operable to measure one or more performance metrics associated with the data transform accelerator. In response to a performance metric of the one or more performance metrics failing to satisfy the target performance metric, the host device may further be operable to automatically tune at least one tunable parameter of the multiple tunable parameters to obtain tuned parameters. The host device may also be operable to update the resource configuration vector in view of the tuned parameters.

The objects and advantages of the embodiments will be realized and achieved at least by the elements, features, and combinations particularly pointed out in the claims.

Both the foregoing general description and the following detailed description are given as examples and are explanatory and not restrictive of the invention, as claimed.

### DESCRIPTION OF DRAWINGS

Example implementations will be described and explained with additional specificity and detail using the accompanying drawings in which:

FIG. 1 illustrates a block diagram of an example system for performance tuning of a data transform accelerator;

FIG. 2 illustrates a block diagram of an example system including additional details associated with the example system of FIG. 1;

FIG. 3 illustrates a flowchart of an example method of implementing performance tuning in a system with a data transform accelerator;

FIG. 4 illustrates a flowchart of another example method of performance tuning of a data transform accelerator; and

FIG. 5 illustrates an example computing device.

### DETAILED DESCRIPTION

A data transform accelerator may be used as a coprocessor device in conjunction with a host device to accelerate data transform operations for various applications, such as data analytics, big data, storage, and/or networking applications. The data transform operations may include, but not be limited to, compression, decompression, encryption, decryption, authentication tag generation, authentication, data deduplication, non-volatile memory express (NVMe) protection information (PI) generation, NVMe PI verification, and/or real-time verification.

A host device may be coupled with a data transform accelerator (e.g., a system) and host software on the host device may be operable to submit commands to the data transform accelerator. Compute resources on the data transform accelerator (e.g., data transform engines) may execute the commands and return the transformed data back to the host device on completion of the data transform operations. Alternatively, or additionally, the transform data may be directed a different device, such as, one or more network interface cards and/or storage arrays.

Some performance metrics that may be associated with the system that includes a host device and a data transform accelerator may include throughput, latency, memory bandwidth consumption by the data transform accelerator, memory bandwidth consumption by the host device, CPU utilization, number of CPU cores used, an amount of processing to transmit results the user applications, and/or input output (IO) operations per unit of time. Throughput may include a number of transform operations completed per unit of time and/or may be a rate of input data processed per unit of time. Latency may include an amount of time to process a command, which may be measured from when the command is submitted from a user application (e.g., running on the host device) to when the result is returned back to the user application, where the result may be transformed data processed by the data transform accelerator.

At least some aspects of the present disclosure describe systems and methods for resource allocation and/or tuning of software in the host device, hardware in the host device, hardware resources in the data transform accelerator, and/or software resources in the data transform accelerator. The automatic performance tuning may depend on specifics of the system, the application, the workload, and/or other aspects as described herein. Further, the automatic performance tuning may perform tuning on one or more performance parameters associated with the system. By automatically performing tuning to the allocated resources, performance metrics of the system may at least satisfy a threshold level of performance.

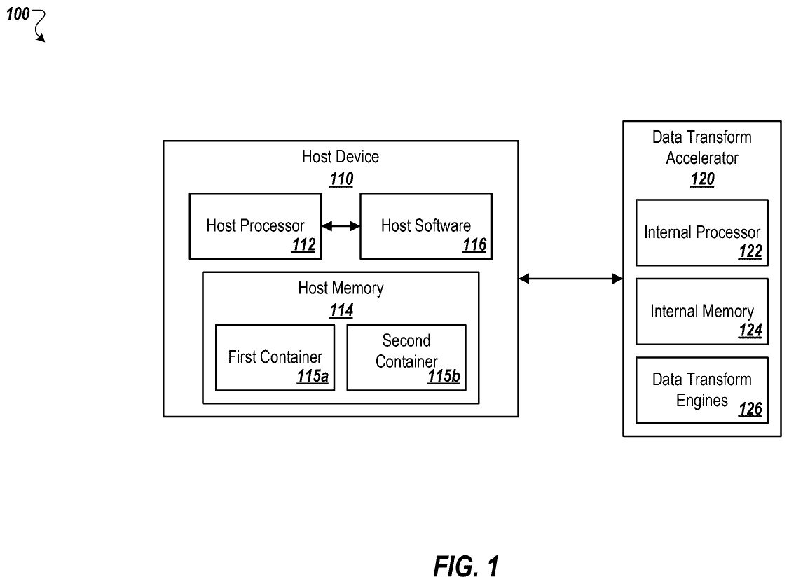

FIG. 1 illustrates a block diagram of an example system 100 for performance tuning of a data transform accelerator system. The system 100 may include a host device 110 and a data transform accelerator 120. The host device 110 may include a host processor 112, a host memory 114, and host software 116. The host memory 114 may include a first container 115a and a second container 115b, referred to collectively as the containers 115. The data transform accelerator 120 may include an internal processor 122, an internal memory 124, and data transform engines 126.

In some instances, the host device 110 (e.g., a host computer, a host server, etc.) may be in communication with the data transform accelerator 120 via a data communication interface (e.g., a Peripheral Component Interconnect express (PCIe) interface, a Universal Serial Bus (USB) interface, and/or other similar data communication interfaces). In some instances, upon a request by a user to transform source data, the host software 116 (e.g., a software driver) on the host device 110 and operated by the host processor 112 may be directed to generate metadata (such as, but not limited to, data transform command pre-data including a command description, a list of descriptors dereferencing a different section of the metadata, and a list of descriptors dereferencing source data and destination data buffers, command pre-data including transform algorithms and associated parameters, source and action tokens describing different sections of the source data and transform operations to be applied to different sections, and/or additional command metadata) with respect to transforming the source data.

In some instances, the host software 116 may generate the metadata in the host memory 114 based on the source data, where the source data may be obtained from one or more sources. For example, the source data may be obtained from a storage associated with the host device 110 (e.g., a storage device), a buffer associated with the host device 110, a data stream from another device, etc. In these and other instances, obtaining the source data may include copying or moving the source data to the host memory 114.

In some instances, the host software 116 may direct the host processor 112 to generate the metadata associated with the source data. For example, the host software 116 may generate and/or submit one or more command requests to the host processor 112, which command requests may be associated with a data transform command and may include a command address. In some instances, the metadata may be stored in one or more input buffers. For example, in instances in which the metadata includes a data transform command that may contain a list of source descriptors, destination descriptors, command pre-data, source and action tokens, and additional command metadata, each of the individual components of the metadata may be stored in individual input buffers (e.g., the data transform command in a first input buffer, pre-data in the second input buffer, the source and action tokens in the third input buffer, and so forth).

In some instances, the input buffers associated with the metadata may be located in the host memory 114. Alternatively, or additionally, the input buffers associated with the metadata may be located in the internal memory 124. Alternatively, or additionally, the input buffers may be located in both the host memory 114 and the internal memory 124. For example, one or more input buffers associated with the metadata may be located in the host memory 114 and one or more input buffers associated with the metadata may be located in the internal memory 124. In these and other instances, the host processor 112 may direct the host software 116 to reserve one or more output buffers that may be used to store an output from the data transform accelerator 120. In some instances, the output buffers may be located in the host memory 114. In some instances, the output buffers may be located in the internal memory 124 of the data transform accelerator 120.

In instances in which the host processor 112 obtains one or more command requests from the host software 116, which may include a request to generate the metadata and/or store the metadata in the internal memory 124 (e.g., in the input buffers located in the internal memory 124) and/or in the host memory 114, the host processor 112 may transmit one or more commands to the data transform accelerator 120 (e.g., such as to a component of the data transform accelerator 120, such as the internal processor 122) via the data communication interface. For example, the internal memory 124 may be accessible and/or addressable by the host processor 112 via the data communication interface, and, in instances in which the data communication interface is PCIe, the internal memory 124 may be mapped to an address space of the host device 110 using a base address register associated with an endpoint of the PCIe (e.g., the data transform accelerator 120).

In some instances, the host software 116 may direct (e.g., via the host processor 112) the data transform accelerator 120 to process a data transform command. For example, the host software 116 may generate one or more command requests, where each command request may each include a command address, and the host software 116 may direct the command addresses to be stored in one or more containers, such as the first container 115a and/or the second container 115b, as described herein. The data transform accelerator 120 may obtain the command addresses that may point to the data transform command.

In some instances, the command address and/or the data transform command may be located in the host memory 114, such as in the first container 115a and/or the second container 115b. In such instances, the data transform accelerator 120 (e.g., the internal processor 122 and/or the data transform engines 126) may obtain the command address and/or may access the data transform command in the host memory 114 using the data communication interface. Alternatively, or additionally, the command address and/or the data transform command may be located in one or more containers disposed the internal memory 124, and the command address may be obtained by the internal processor 122 and/or the data transform engines 126.

In some instances, the data transform command may be used by the data transform accelerator 120 to transform the source data based on data transform operations included in the data transform command. In some instances, the data transform operations that may be performed as directed by the data transform command may be performed by the data transform engines 126. In some instances, the data transform engines 126 may be arranged based on the data transform command and/or the metadata (e.g., the metadata stored in the host memory 114 and/or stored in the internal memory 124), such that the data transform engines 126 may form a data transform pipeline that may be configured to perform the data transform operations to the source data.

The data transform accelerator 120 and/or the components included therein (e.g., the internal processor 122, the internal memory 124, and/or the data transform engines 126) may be implemented using various systems and/or devices. For example, the data transform accelerator 120 may be implemented in hardware, software, firmware, a field-programmable gate array (FPGA), a graphics processing unit (GPU), and/or a combination of any of the above listed implementations.

The data transform accelerator 120 may be operable to perform data transform operations using one or more pipelines, the pipelines including a configuration of the data transform engines 126. The pipelines in the data transform accelerator 120 may be described as performing data transform operations in at least two directions, an encode direction and/or a decode direction. The encode direction data transform operations performed by a first pipeline in the data transform accelerator 120 may include one or more of NVMe PI verification on input data, compression, deduplication hash generation, padding, encryption, cryptographic hash generation, and NVMe PI generation on encoded data, and/or real-time verification on the encoded data. The decode direction data transform operations performed by a second pipeline in the data transform accelerator 120 may include one or more of decryption (e.g., with or without verification generated on the input data and/or the transformed data), depadding, decompression, deduplication hash generation on input data and/or transformed data (e.g., obtained from the input data), and/or NVMe PI verification on the encoded data.

In these and other instances, the host device 110 may use the data communication interface to transmit metadata to the data transform accelerator 120, which the internal processor 122 may direct to be stored in the internal memory 124 and the internal processor 122 may return the command address of the stored metadata to the host processor 112. Alternatively, or additionally, the host device 110 may use the data communication interface to transmit metadata directly to the internal memory 124 of the data transform accelerator 120.

As described, the host software 116 may submit one or more command requests to the host processor 112 and/or the data transform accelerator 120. In response to the command requests, a command structure may be generated (e.g., by the host processor 112, the internal processor 122, and/or a combination thereof) that may be located in the host memory 114, the internal memory 124, and/or a combination of the host memory 114 and the internal memory 124. Subsequently, the command address associated with the command structure may be stored in the first container 115a, the second container 115b, and/or one or more containers disposed in the internal memory 124 (not illustrated in FIG. 1, and will be discussed with respect to FIG. 1 as the containers disposed in the host memory 114, but it will be appreciated that the containers may be disposed in the internal memory 124). In these and other instances, the command address may be accessible by the data transform accelerator 120.

The containers 115 may be initialized at a time when the data transform accelerator 120 may be initialized. The containers 115 may be one or more command pointer rings and may be operable to store the command addresses that may be generated and/or store requests by one or more command requests from the host software 116. In some instances, one or more threads on the CPUs of the host processor 112 and/or one or more applications of the host software 116 may submit command requests for storing command addresses and the containers 115 may be locked for mutual exclusion, which may remove a likelihood of race conditions associated with storing the command addresses in the first container 115a and/or the second container 115b.

Performing performance tuning in the system 100 may be based on one or more parameters associated with the system 100, such as parameters in the host device 110 and/or parameters in the data transform accelerator 120. The number of the containers 115 in the host device 110 may be a parameter that may affect the performance tuning. For example, a limited number of the containers 115 may increase contention between threads submitting commands and/or retrieving results. In another example, an excess of the containers 115 may reduce performance in the system 100 due to an excess of cache-coherent traffic and/or an excess of resource consumption (e.g., the host memory 114, the internal memory 124, and/or a cache associated with either the host device 110 or the data transform accelerator 120). Alternatively, or additionally, a number of commands that may be stored in the containers 115 may affect the latency in the system 100. For example, limiting the number of commands stored in the containers 115 may contribute to limiting the latency in the system 100.

Another parameter may be a number of threads in the host device 110. The threads may be configured to submit commands to the data transform accelerator 120 and/or may be configured to obtain results from the data transform accelerator 120. In instances in which the number of threads fail to satisfy a lower threshold and the system 100 includes multiple data transform accelerators, parallelism between the multiple data transform accelerators may not be obtained (which may otherwise be obtainable but for the number of threads in the example). Alternatively, or additionally, in instances in which the number of threads satisfy an upper threshold, an additional (and/or unnecessary) number of CPU cycles may be consumed, context switching overhead may be increased, additional demands may be placed on the cache, and/or general performance of the system 100 may be reduced.

Another parameter may be interrupt throttling that may occur subsequent to results from the data transform accelerator 120 being obtained. As interrupts may be throttled, CPU utilization in the host processor 112 may be reduced and/or throughput may be improved. Alternatively, or additionally, latency in the transform operations performed by the data transform accelerator 120 may be increased.

A number of resources that may be operating in the data transform accelerator 120 (and/or in each data transform accelerator in instances in which multiple data transform accelerators are present), such as the resources being used by the data transform engines 126, may be another parameter associated with performance tuning in the system 100. For example, in instances in which more data transform engines 126 are included in the data transform accelerator 120 than may be used for a particular data transform operation, the excess data transform engines 126 may be disabled and/or turned off to reduce power consumption by the system 100.

Load balancing in the system 100 may be another parameter that may be tuned as needed to adjust performance in the system 100. In some instances, the load balancing in the system 100 may be operable to distribute the data transform operations across more than one of the containers 115 and/or across the data transform engines 126. Alternatively, or additionally, the load balancing in the system 100 may be operable to distribute the data transform operations based on a general schedule of consumption of software resources and/or hardware resources associated with the data transform accelerator 120. As commands may be submitted to the data transform accelerator 120, the submission thereof may be load balanced using one or more algorithms, which may affect the performance of the system 100. Some of the load balancing algorithms may include round robin, queue depth-based load balancing, CPU core to container bindings, and/or classes of service may each provide trade-offs in the performance and/or the performance metrics of the system 100.

Another parameter may be a selection of a CPU core in the host device 110 (e.g., one CPU core of the host processor 112) for submission of the commands to the data transform accelerator 120. For example, some CPU cores may be faster than other CPU cores and/or may include more threads than other CPU cores, where the CPU cores may operate the threads that may submit commands to the data transform accelerator 120 and/or may retrieve results from the data transform accelerator 120. The importance of the selection of a CPU core in the host device 110 may be emphasized in instances in which memory bandwidth availability from different non-uniform memory access (NUMA) nodes may be limited and/or restricted. For example, in instances in which CPU cores are selected across different NUMA nodes as part of performance tuning, the system 100 may experience improved performance relative to instances in which CPU cores are selected from a limited number of NUMA nodes.

In some instances, an architecture (e.g., a platform architecture) associated with the host device 110, the data transform accelerator 120, and/or the components included in either the host device 110 and/or the data transform accelerator 120 may affect the performance tuning of the system 100. Some of the architecture considerations associated with the host device 110 and/or the data transform accelerator 120 as part of performance tuning of the system 100 may include uniform memory access (UMA) vs. NUMA, a number of NUMA nodes included in the NUMA architecture, a number of CPU cores available, a clock frequency of the CPU cores, available memory bandwidth, a memory configuration, and/or a cache architecture. In some instances, the performance tuning as described herein may differ for different platform architectures based on differences between the different platform architectures. For example, a first platform architecture may have a first number of available threads and a first number of available containers and a second platform architecture may have a second number of available threads and a second number of available containers, and the performance tuning for each of the platform architectures may differ based on the different parameters included therein.

Performance tuning in the system 100 may include determining values for resources and/or determining configurations for the resources in the data transform accelerator 120. In some instances, different execution modes of submitting commands from the host device 110 (e.g., from the host software 116) to the data transform accelerator 120 may affect the performance tuning in the system 100. The following are provided as examples of execution modes.

A first execution mode may be synchronous command submission from a kernel space of the host processor 112, where the software in the kernel space may wait for results from the data transform accelerator 120 and/or may block other command submissions from the same thread of execution after submitting the command to the data transform accelerator 120 until results from the data transform accelerator 120 become available. Alternatively, or additionally, a second execution mode may be synchronous command submission from a user space of the host processor 112, where the software in the user space may wait for results from the data transform accelerator 120 and/or may block other command submissions after submitting the command to the data transform accelerator 120 until results from the data transform accelerator 120 become available.

A third execution mode may be asynchronous command submission from the kernel space of the host processor 112, where the software in the kernel space may not block other command submissions after submitting the command to the data transform accelerator 120, and the software in the kernel space may be notified when results of the data transform operations may be available. Alternatively, or additionally, a fourth execution mode may be asynchronous command submission from the user space of the host processor 112, where the software in the user space may not block other command submissions after submitting the command to the data transform accelerator 120, and the software in the kernel space may be notified when results of the data transform operations may be available. Alternatively, or additionally, one or more of the first execution mode, the second execution mode, the third execution mode, and/or the fourth execution mode may be combined and implemented in the system 100 as part of performance tuning therein.

In some instances, the performance tuning in the system 100 may include determining values for the parameters in view of the architecture modes and/or execution modes, and tradeoffs that may be performed in the system 100. In some instances, one or more of the performance metrics may be weighted to increase or decrease an emphasis on a particular performance metric (and/or group of performance metrics). Alternatively, or additionally, the performance tuning may be implemented for a particular workload performed by the system 100. In some instances, a workload may be determined based on a data block size and/or the data transform operations to be performed. For example, a first workload may differ from a second workload based on the data transform operations differing between the first workload and the second workload, and/or different data block sizes being implemented between the first workload and the second workload.

In some instances, the performance tuning in the system 100 may occur during different operational modes associated with the system 100. For example, the performance tuning may be performed initially using a synthetic workload, where the synthetic workload may be representative of a subsequent mission workload. In such instances, the performance tuning may be made in view of optimizing performance metrics that may be obtained, such as from a user of the system 100. For example, in some instances, the user may provide a constrained resource that the system 100 may optimize around (e.g., the user may seek for a best latency and/or a best throughput in view of a fixed or minimized CPU utilization). In such instances, the performance tuning may be performed in view of particular tuning desires, such as provided by the user and/or resources available in the system 100. Resources in the system 100 (including resources in the data transform accelerator 120) may be dimensioned in view configuration parameter values, such as optimizing the division of the resources based on the configuration parameter values. As the resource dimensioning is completed, the configuration of the resources may be saved for future use, such as in the subsequent mission workload.

Alternatively, or additionally, the performance tuning may be adaptively performed, such as during execution of the mission mode. In such instances, software (such as the host software 116) may monitor the workload profile and/or the performance metrics. The software may be in the host device 110 and/or in the data transform accelerator 120. As the key performance metrics are measured, the resources in the system 100 may be tuned to optimize the performance metrics of the system 100. The tuning of the resources may be performed in the foreground and/or in the background of operations performed by the system 100. For example, in instances in which the workload of the system 100 changes to a new workload, the configuration of the resources in the system 100 may be tuned in view of new objectives associated with the new workload, and the resources may be tuned to optimize the resources in view of the new workload profile.

Alternatively, or additionally, changes to the target performance metrics may cause tuning to the resources to optimize the resources relative to the target performance metrics. In some instances, weights associated with the performance metrics may be adjusted which may cause the resources in the system 100 to be tuned accordingly. For example, the target performance metrics may vary based on workload, time of day, service level agreement, power savings, and/or other criteria, and in response to the changes to the target performance metrics, the resources may be tuned accordingly which may result in a different configuration of the resources in view of the changes to the target performance metrics.

Modifications, additions, or omissions may be made to the system 100 without departing from the scope of the present disclosure. For example, the designations of different elements in the manner described is meant to help explain concepts described herein and is not limiting. Further, the system 100 may include any number of other elements or may be implemented within other systems or contexts than those described. For example, any of the components of FIG. 1 may be divided into additional or combined into fewer components.

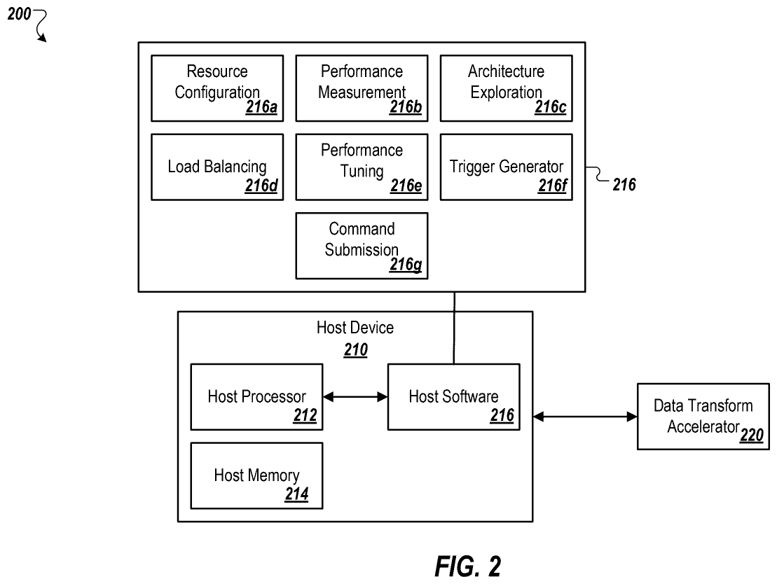

FIG. 2 illustrates a system 200 including additional details associated with the system 100 of FIG. 1. The system 200 may include a host device 210 and a data transform accelerator 220. The host device 210 may include a host processor 212, host memory 214, and host software 216. In some instances, the host device 210 and the data transform accelerator 220 may be the same or similar to the host device 110 and the data transform accelerator 120 of FIG. 1, respectively. In some instances, the host processor 212 and the host memory 214 may be the same or similar as the host processor 112 and the host memory 114, respectively, and/or the host processor 212 and the host memory 214 may be operable to perform the same or similar operations as described relative to the host processor 112 and the host memory 114, respectively.

In some instances, the host software 216 may include a number of applications and/or modules that may facilitate operations performed by the host software 216 as described herein. The modules that may be part of the host software 216 may include a resource configuration module 216a, a performance measurement module 216b, an architecture exploration module 216c, a load balancing module 216d, a performance tuning module 216e, a trigger generator 216f, and a command submission module 216g.

The resource configuration module 216a may be operable to obtain a resource configuration vector in the system 200. In some instances, the resource configuration module 216a may generate the resource configuration vector based on characteristics of the system 200, including a number of containers in the system 200, a depth of each container in the system (e.g., in terms of a number of outstanding commands in a particular container and/or a maximum number of outstanding commands), a number of threads submitting commands to the data transform accelerator 220, a particular load balancing algorithm, a number of result retriever threads (e.g., threads that may be used to obtain results from the data transform accelerator 220) that may be used in the system 200, and/or other resource configurations. The resource configuration module 216a may provide the resource configuration vector, as needed, for configuring the data transform accelerator 220 and/or for tuning the data transform accelerator 220.

The performance measurement module 216b may be operable to determine a performance metric associated with the system 100 and/or the data transform accelerator 220. In some instances, the performance measurement module 216b may measure at least throughput, latency, CPU core utilization, and/or memory bandwidth consumption associated with the system 200.

The architecture exploration module 216c may be operable to determine an architecture associated with the system 200, which architecture may affect the performance tuning of the system 200. For example, the architecture exploration module 216c may be operable to determine uniform memory access (UMA) vs. NUMA, a number of NUMA nodes included in the NUMA architecture, a number of CPU cores available, a clock frequency of the CPU cores, available memory bandwidth, a memory configuration, and/or a cache architecture. In some instances, the resource configuration module 216a may use information obtained from the architecture exploration module 216c to determine values for the resource configuration vector.

The load balancing module 216d may be operable to determine and/or implement a load balancing algorithm as part of performance tuning in the system 200, as described herein. In some instances, the load balancing algorithms (e.g., which may be utilized to schedule the consumption of resources in the system 200) that may be implemented by the load balancing module 216d may include round robin, queue depth-based load balancing, CPU core to container bindings, and/or any other classes of service.

The performance tuning module 216e may be operable to determine various configurations and/or changes that may be implemented in the system 200 to perform a performance tuning of the system 200, as described herein. In some instances, the performance tuning module 216e may establish an initial configuration for the system 200 and/or the data transform accelerator 220 based on a synthetic workload. In some instances, the performance tuning module 216e may be operable to continually perform (and/or adaptively perform) the performance tuning with respect to the system 200, such as during the execution of a mission workload. In some instances, the performance tuning module 216e may be responsible for updating the resource configuration vector generated from the resource configuration module 216a. For example, the performance tuning module 216e may be operable to change one or more values of the resource configuration vector based on a comparison between a target performance of the system 200 and a measured performance of the system 200. In the example, the performance tuning may be performed using a workload that may be a synthetic workload and/or a mission workload.

The trigger generator module 216f may be operable to monitor a difference between target performance metrics and measured performance metrics associated with the system 200. The measured performance metrics may be obtained during and/or after the system 200 executes a workload (e.g., a synthetic workload and/or a mission workload). Based on the determined difference, one or more triggers may be generated by the trigger generator module 216f and the one or more triggers may be communicated to at least the performance tuning module 216e. In some instances, the performance tuning module 216e may utilize the triggers to update the resource configuration vector, which may adapt the current performance metrics to be closer to the target performance metrics.

The command submission module 216g may be operable to submit commands from the host device 210 to the data transform accelerator 220. The commands from the command submission module 216g may be operable to direct the data transform accelerator 220 with respect to the data transform operations to perform.

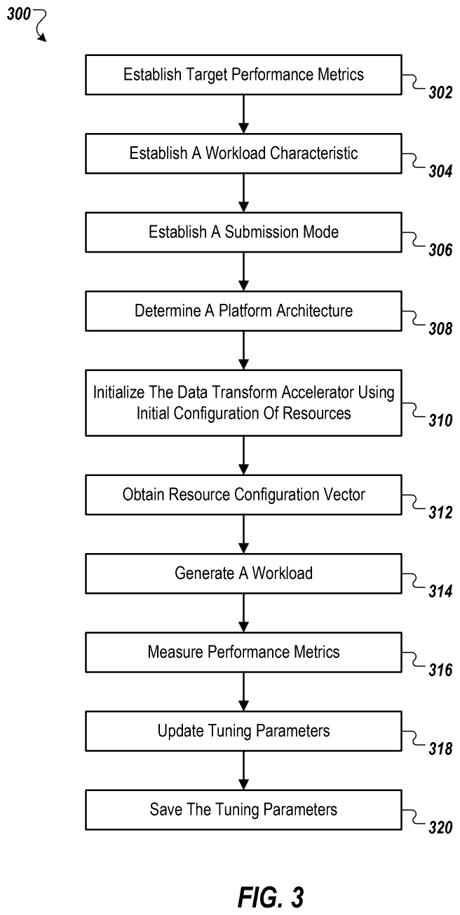

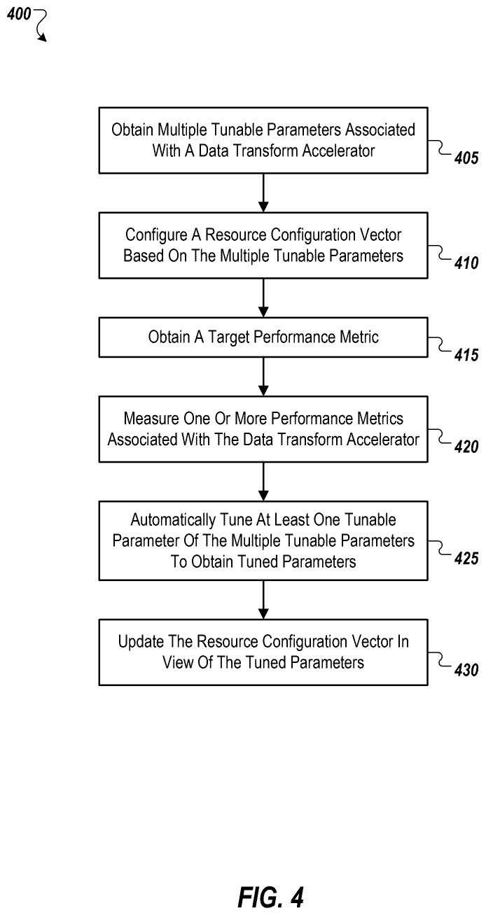

FIG. 3 illustrates a flowchart of an example method 300 of implementing performance tuning in a system with a data transform accelerator, and FIG. 4 illustrates a flowchart of an example method 400 of performance tuning of a data transform accelerator. The method 300 and/or the method 400 may be performed by processing logic that may include hardware (circuitry, dedicated logic, etc.), software (such as is run on a general purpose computer system or a dedicated machine), or a combination of both, which processing logic may be included in any computer system or device such as the host device 110 or the data transform accelerator 120 of FIG. 1.

For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification may be capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

The method 300 may begin at block 302 where target performance metrics and/or an objective function may be established. The objective function may include a weighted combination of the target performance metrics, which may include trade-offs between at least throughput, latency, CPU core utilization, and/or memory bandwidth requirements.

At block 304, a workload characteristic may be established for data processing by the data transform accelerator 120 of FIG. 1, which may include one or more data transform operations. The data transform operations may include encode or decode operations and/or specific transform operations involved in the encode and/or the decode operations. Alternatively, or additionally, the data transform operations may include a mix of block sizes of data that the data transform accelerator 120 may perform data transform operations on. For example, a first portion of the commands (e.g., a first half) may be used in the encode direction and a second portion of the commands (e.g., a second half) may be used in the decode direction. Of the encode direction commands, some may be used for compression of a data block of 4 KB size and some may be used for encrypting data blocks of 32 KB size. Continuing the example, the decode direction commands may be used for decompression for blocks of 16 KB size. Alternatively, or additionally, the workload characteristic may include a mix of datasets, where the datasets may include variations in compressibility relative to one another. The compressibility variations between the datasets may facilitate performance tuning using the parameters in the system 100 (e.g., number of containers, number of commands per container, CPU core selection, etc.), such that an optimization of the parameters in the system 100 may utilize the memory bandwidth available to the system 100.

At block 306, a submission mode for the commands may be established, which may also define the workload. The submission mode may be one or more of the submission modes described herein (e.g., asynchronous kernel space, asynchronous user space, synchronous kernel space, synchronous user space).

At block 308, platform architecture configurations may be determined. Some of the platform architecture configurations may include a number of NUMA nodes, a number of processors, a number of CPU cores in each of the processors, a memory configuration, a number of CPU cores per NUMA node (e.g., in instances in which a NUMA architecture is implemented), a clock frequency associated with the CPU cores, a memory bandwidth of the system, a memory bandwidth available to different NUMA nodes, etc. In some instances, the platform architecture configurations may be determined by the host software 116 of FIG. 1.

At block 310, the data transform accelerator 120 and/or software associated with the data transform accelerator 120 may be initialized with an initial configuration of the resources available to the data transform accelerator 120. The initial configuration may be a pre-determined and/or a pre-stored configuration that may be based on tuning performed in a related data transform accelerator. Alternatively, or additionally, the initial configuration may be a default configuration associated with the data transform accelerator 120.

At block 312, the host software 116 may obtain a resource configuration vector to be used in the system 100 of FIG. 1. The host software 116 may be running on the host operating system or a guest operating system on a virtual machine in a virtualized environment. In some instances, the resource configuration vector may include a number of containers in the system 100, a number of threads submitting commands to the data transform accelerator 120, a depth of each container, a particular load balancing algorithm, a number of result retriever threads that may be used in the system 100, and/or other resource configurations. The data transform accelerator 120 and/or the host software 116 may be configured in view of the resources included in the resource configuration vector and/or the values associated therewith. For example, the data transform accelerator 120 may be tuned in view of the resource configuration vector.

At block 314, a workload may be generated based on characteristics of the workload that was previously established and/or based on a submission mode of the commands. The workload may include one or more commands for data transform operations, and where the workload may include source data and/or metadata. The workload may be transmitted to the data transform accelerator 120 including the resources and/or the resource configuration vector.

At block 316, as the data transform accelerator 120 performs operations, the performance of one or more metrics may be measured, such as by the host software 116. The measured metrics may include throughput, latency, CPU core utilization, and/or memory bandwidth consumption. Subsequently, the measured performance metrics may be used to evaluate the performance of the system 100 and/or the data transform accelerator 120.

At block 318, in instances in which the measured performance metrics fail to satisfy a desired performance threshold (e.g., such as relative to throughput, latency, CPU core utilization, and/or memory bandwidth consumption), one or more updates to the parameters included in the resource configuration vector may be made.

In some instances, the updates may be a pre-defined step size. Alternatively, or additionally, the updates may be an adaptively defined step size. Alternatively, or additionally, some updates may be a combination, where a first resource may be updated in a pre-defined step size (e.g., an index associated with the load balance algorithm method) and a second resource may be updated in an adaptive step size (e.g., a number of threads submitting commands, a number of containers, etc.). Once updates are made to the resources, at least some of the above-described process may be repeated to determine if the performance metrics are satisfied in view of the updates to the resources.

At block 320, in instances in which the measured performance metrics satisfy the desired performance threshold, the configuration of the tuning parameters may be saved. The saved tuning parameters may subsequently be used in other operations by the data transform accelerator 120, such as in a mission mode of operations. Alternatively, or additionally, the saved tuning parameters may be used by the host device 110 in conjunction with another data transform accelerator (e.g., a second data transform accelerator), which may include data transform operations that may be the same or that may differ from the data transform operations that resulted in the saved tuning parameters. In some instances, the above-described process may be performed in multiple phases. For example, a first phase may perform a coarse performance tuning, which may include resource configurations (e.g., determining a number of containers to be used in the system 100). A second phase may perform a fine performance tuning, which may include determining parameters to optimize the performance metrics.

In some instances, a first performance tuning (e.g., in accordance with the method 300 as described herein) may be performed using a first workload. At least some of the results from the first performance tuning may be saved, such as a memory bandwidth measurement associated with the CPU cores. In a subsequent performance tuning, a different workload may be utilized that may include a low compression ratio relative to the first workload, where the low compression ratio may be used to test memory bandwidth. The memory bandwidth may be measured from different NUMA nodes by performing one or more command submissions associated with the second workload and using the memory bandwidth measurement obtained from the first performance tuning. Alternatively, or additionally, the number of CPU cores may be updated in the subsequent performance tuning, and the selection of the CPU cores may be performed in view of the memory bandwidth available to the system 100.

The following description provides an example method of performing performance tuning in a system when a change to the system 100 occurs, which may include similarities to the method 300 of FIG. 3. In some instances, the change to the system 100 may include a change to the workload and/or a change to the desired performance metrics associated with the system 100. Target performance metrics and/or an objective function may be established. The objective function may include a weighted combination of the target performance metrics, which may include trade-offs between at least throughput, latency, CPU core utilization, and/or memory bandwidth.

A submission mode for the commands may be established, which may also define the workload. The submission mode may be one or more of the submission modes described herein (e.g., asynchronous kernel space, asynchronous user space, synchronous kernel space, synchronous user space).

The data transform accelerator 120 and/or software associated with the data transform accelerator 120 may be initialized with an initial configuration of the resources available to the data transform accelerator 120. The initial configuration may be a pre-determined and/or pre-stored configuration that may be based on tuning performed in a related data transform accelerator. Alternatively, or additionally, the initial configuration may be a default configuration associated with the data transform accelerator 120.

The system 100 may begin transmitting commands to the data transform accelerator 120 in a mission mode for the performance of data transform operations. The host software 116 may be operable to monitor the workload and/or the performance metrics associated with the data transform accelerator 120.

In instances in which the workload and/or the workload characteristics change from an initial workload (or initial workload characteristics), performance tuning may be enabled. Alternatively, or additionally, the performance tuning may be enabled in response to one or more of the performance metrics deviating from target performance metrics and/or deviating from a determined optimal performance metrics (such as determined using a synthetic workload, or from previous data transform operations from the data transform accelerator 120 or a different data transform accelerator). Alternatively, or additionally, the performance tuning may be enabled in response to a platform configuration change, a change to the host software 116, and/or a change to one or more of the resources in the host device 110.

As the data transform accelerator 120 performs operations, the performance of one or more metrics may be measured, such as by the host software 116. The measured metrics may include throughput, latency, CPU core utilization, and/or memory bandwidth consumption. Subsequently, the measured performance metrics may be used to evaluate the performance of the system 100 and/or the data transform accelerator 120.

In instances in which the measured performance metrics fail to satisfy a desired performance threshold (e.g., such as relative to throughput, latency, CPU core utilization, and/or memory bandwidth consumption), one or more updates to the parameters included in the resource configuration vector may be made, as described herein (e.g., similar to those described relative to the first example method). Alternatively, or additionally, in instances in which the measured performance metrics satisfy the desired performance threshold, the configuration of the tuning parameters may be saved. Once updates are made to the resources, at least some of the above-described processes may be repeated to determine if the performance metrics are satisfied in view of the updates to the resources.

The saved tuning parameters may subsequently be used in other operations by the data transform accelerator 120, such as in a mission mode of operations. In some instances, the above-described process may be performed in multiple phases. For example, a first phase may perform a coarse performance tuning, which may include resource configurations (e.g., determining a number of containers to be used in the system 100). A second phase may perform a fine performance tuning, which may include determining parameters to optimize the performance metrics.

In these and other instances, the performance tuning may be performed when the commands are submitted from the host software 116. Alternatively, or additionally, the performance tuning may be performed when virtualization is implemented in the host device 110. In instances in which virtualization is used, performance tuning may be performed in the software environment running on the guest operating system in one or more virtual machines. In such instances, workload and/or performance metrics measurements may be performed in each virtual machine and/or resource optimization may be performed considering the resources available to each virtual machine considering performance metrics objective function which may be defined differently for each virtual machine. In these and other instances, the performance tuning may be applied to the data transform accelerator 120, a network interface card (NIC), and/or other computing systems.

Modifications, additions, or omissions may be made to the method 300 without departing from the scope of the present disclosure. For example, the designations of different elements in the manner described is meant to help explain concepts described herein and is not limiting. Further, the method 300 may include any number of other elements or may be implemented within other systems or contexts than those described.

Referring now to FIG. 4, the method 400 may begin at block 405 where multiple tunable parameters associated with a data transform accelerator operable to perform data transform operations may be obtained. In some instances, the multiple parameters may include one or more of: a number of containers containing commands for the data transform accelerator, a depth of the containers, a number of acceleration threads, a load balancing algorithm, and/or a number of result retriever threads.

At block 410, a resource configuration vector may be configured based on the multiple tunable parameters. In some instances, the resource configuration vector may be configured by a host device that may be in communication with the data transform accelerator. Alternatively, or additionally, the resource configuration vector may be determined in view of a first platform architecture. In some instances, a second resource configuration vector may be determined in view of a second platform architecture, where compute resources available in the first platform architecture may differ from the compute resources available in the second platform architecture.

At block 415, a target performance metric may be obtained. Alternatively, or additionally, a workload may be obtained, where the workload may be used by the data transform accelerator to perform data transform operations.

At block 420, one or more performance metrics associated with the data transform accelerator may be measured.

At block 425, at least one tunable parameter of the multiple tunable parameters may be automatically tuned to obtain tuned parameters. In some instances, the tuned parameters may be obtained in response to a performance metric of the one or more performance metrics failing to satisfy the target performance metric. In some instances, the automatic tuning of the tunable parameter may be performed by the host device that may be in communication with the data transform accelerator. In some instances, the multiple tunable parameters may be tuned to optimize at least one system performance metric. The system performance metric may include one or more of throughput, latency, memory bandwidth consumption, and CPU utilization. In some instances, the system performance metric may be optimized in response to user input that may be obtained from a user.

At block 430, the resource configuration vector may be updated in view of the tuned parameters.

Modifications, additions, or omissions may be made to the method 400 without departing from the scope of the present disclosure. For example, in some instances, the method 400 may further include saving the resource configuration vector. Alternatively, or additionally, the resource configuration vector may be applied to a second data transform accelerator performing the data transform operations. In some instances, the resource configuration vector associated with the data transform accelerator may be obtained using a synthetic workload.

In another example, in some instances, the method 400 may further include iteratively updating the resource configuration vector. In some instances, the update to the resource configuration vector may be in response to one or more changes to a workload provided to the data transform accelerator. In some instances, the workload may be a synthetic workload and a second workload may be a mission workload.

In another example, the designations of different elements in the manner described is meant to help explain concepts described herein and is not limiting. Further, the method 400 may include any number of other elements or may be implemented within other systems or contexts than those described.

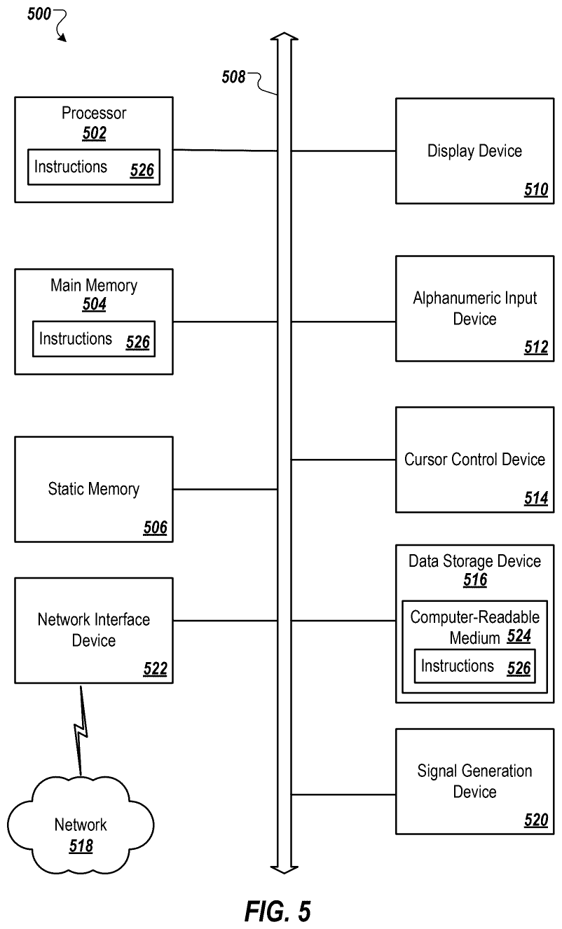

FIG. 5 illustrates an example computing device 500 within which a set of instructions, for causing the machine to perform any one or more of the methods discussed herein, may be executed. The computing device 500 may include a mobile phone, a smart phone, a netbook computer, a rackmount server, a router computer, a server computer, a personal computer, a mainframe computer, a laptop computer, a tablet computer, a desktop computer, or any computing device with at least one processor, etc., within which a set of instructions, for causing the machine to perform any one or more of the methods discussed herein, may be executed. In alternative implementations, the machine may be connected (e.g., networked) to other machines in a LAN, an intranet, an extranet, or the Internet. The machine may operate in the capacity of a server machine in client-server network environment. The machine may include a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” may also include any collection of machines that individually or jointly execute a set (or multiple sets) of instructions to perform any one or more of the methods discussed herein.

The computing device 500 includes a processing device 502 (e.g., a processor), a main memory 504 (e.g., read-only memory (ROM), flash memory, dynamic random access memory (DRAM) such as synchronous DRAM (SDRAM)), a static memory 506 (e.g., flash memory, static random access memory (SRAM)) and a data storage device 516, which communicate with each other via a bus 508.

The processing device 502 represents one or more general-purpose processing devices such as a microprocessor, central processing unit, or the like. More particularly, the processing device 502 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 502 may also include one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein.

The computing device 500 may further include a network interface device 522 which may communicate with a network 518. The computing device 500 also may include a display device 510 (e.g., a liquid crystal display (LCD) or a cathode ray tube (CRT)), an alphanumeric input device 512 (e.g., a keyboard), a cursor control device 514 (e.g., a mouse) and a signal generation device 520 (e.g., a speaker). In at least one implementation, the display device 510, the alphanumeric input device 512, and the cursor control device 514 may be combined into a single component or device (e.g., an LCD touch screen).

The data storage device 516 may include a computer-readable storage medium 524 on which is stored one or more sets of instructions 526 embodying any one or more of the methods or functions described herein. The instructions 526 may also reside, completely or at least partially, within the main memory 504 and/or within the processing device 502 during execution thereof by the computing device 500, the main memory 504 and the processing device 502 also constituting computer-readable media. The instructions may further be transmitted or received over the network 518 via the network interface device 522.

While the computer-readable storage medium 524 is shown in an example implementation to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

Terms used in the present disclosure and especially in the appended claims (e.g., bodies of the appended claims) are generally intended as “open terms” (e.g., the term “including” should be interpreted as “including, but not limited to.”).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is expressly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase preceding two or more alternative terms, whether in the description, claims, or drawings, should be understood to contemplate the possibilities of including one of the terms, either of the terms, or both of the terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although implementations of the present disclosure have been described in detail, various changes, substitutions, and alterations could be made hereto without departing from the spirit and scope of the present disclosure.

What is claimed is:

1. A method, comprising:
obtaining a plurality of tunable parameters associated with a data transform accelerator operable to perform data transform operations;
configuring a resource configuration vector based on the plurality of tunable parameters;
obtaining a target performance metric;
measuring one or more performance metrics associated with the data transform accelerator;
in response to a performance metric of the one or more performance metrics failing to satisfy the target performance metric, automatically tuning at least one tunable parameter of the plurality of tunable parameters to obtain tuned parameters; and
updating the resource configuration vector in view of the tuned parameters.

2. The method of claim 1, further comprising:
saving the resource configuration vector; and
applying the resource configuration vector to a second data transform accelerator performing the data transform operations.

3. The method of claim 2, wherein the resource configuration vector associated with the data transform accelerator is obtained using a synthetic workload.

4. The method of claim 1, further comprising iteratively updating the resource configuration vector in response to one or more changes to a workload provided to the data transform accelerator.

5. The method of claim 4, wherein the workload is a synthetic workload and a second workload is a mission workload.

6. The method of claim 1, wherein the resource configuration vector is configured by a host device that is in communication with the data transform accelerator.

7. The method of claim 1, wherein the automatic tuning of the at least one tunable parameter is performed by a host device that is in communication with the data transform accelerator.

8. The method of claim 1, wherein the plurality of tunable parameters comprise one or more of: a number of containers containing commands for the data transform accelerator, a depth of the containers, a number of acceleration threads, a load balancing algorithm, and a number of result retriever threads.

9. The method of claim 1, wherein:
the resource configuration vector is determined in view of a first platform architecture;
a second resource configuration vector is determined in view of a second platform architecture; and
compute resources available in the first platform architecture differ from the compute resources available in the second platform architecture.

10. The method of claim 1, wherein the plurality of tunable parameters are tuned to optimize at least one system performance metric, the system performance metric comprising one or more of throughput, latency, memory bandwidth consumption, and CPU utilization.

11. The method of claim 10, wherein the system performance metric is optimized in response to user input obtained from a user.

12. A system, comprising:
a data transform accelerator operable to perform data transform operations; and
a host device in communication with the data transform accelerator, wherein the host device is operable to:
obtain a plurality of tunable parameters associated with the data transform accelerator;
configure a resource configuration vector based on the plurality of tunable parameters;
obtain a target performance metric;
measure one or more performance metrics associated with the data transform accelerator;
in response to a performance metric of the one or more performance metrics failing to satisfy the target performance metric, automatically tune at least one tunable parameter of the plurality of tunable parameters to obtain tuned parameters; and
update the resource configuration vector in view of the tuned parameters.

13. The system of claim 12, wherein the host device is further operable to:
save the resource configuration vector; and
apply the resource configuration vector to a second data transform accelerator performing the data transform operations.

14. The system of claim 13, wherein the resource configuration vector associated with the data transform accelerator is obtained using a synthetic workload.

15. The system of claim 12, wherein the host device is further operable to iteratively update the resource configuration vector in response to one or more changes to a workload provided to the data transform accelerator.

16. The system of claim 15, wherein the workload is a synthetic workload and a second workload is a mission workload.

17. The system of claim 12, wherein the resource configuration vector is configured by the host device and the automatic tuning of the at least one tunable parameter is performed by the host device.

18. The system of claim 12, wherein the plurality of tunable parameters comprise one or more of: a number of containers containing commands for the data transform accelerator, a depth of the containers, a number of acceleration threads, a load balancing algorithm, and a number of result retriever threads.

19. The system of claim 12, wherein:
the resource configuration vector is determined in view of a first platform architecture;
a second resource configuration vector is determined in view of a second platform architecture; and
compute resources available in the first platform architecture differ from the compute resources available in the second platform architecture.

20. The system of claim 12, wherein the plurality of tunable parameters are tuned to optimize at least one system performance metric, the system performance metric comprising one or more of throughput, latency, memory bandwidth consumption, and CPU utilization.
